(19) United States
(12) Patent Application Publication
(10) Pub. No.: US 2010/0212165 A1
(43) Pub. Date: Aug. 26, 2010

(54) Scissors for hairstylist

(75) Inventors: Alessandro Parnazzini, Pescara (IT); Rocco Blasioli, Chieti Scalo (IT)

Correspondence Address: ABELMAN, FRAYNE & SCHWAB, 666 THIRD AVENUE, 10TH FLOOR, NEW YORK, NY, 10017, US

(73) Assignee: Nuova Fapam S.R.L.

(21) Appl. No.: 12/660,121

(22) Filed: Feb. 19, 2010

(30) Foreign Application Priority Data
Feb. 20, 2009 (IT) MI2009U000052

(51) Int. Cl. B26B 13/10; B26B 13/00

(52) U.S. Cl. 30/226; 30/230; 30/232

(57) ABSTRACT

The present invention relates to a new type of scissors for hairstylist which allows the hairstylist to optimise the cutting operations, in particular by eliminating the need to go over the tip of the locks of hair with the tip of the straight scissors or to go over the locks of hair with trimming scissors in order to move the edge of the lock of hair, which is straight when the lock of hair is cut using the straight scissors or other similar known models of the prior art. Instead, the scissors according to the present invention allows in a single cutting operation to obtain a “perfectly irregular” end of the lock of hair, obtaining an irregular line of perfect measure and combining the gripping comfort and the manageability of the scissors for hairstylists with the efficacy of a tool capable of obtaining a non-straight cut of the lock of hair, conferring in this manner a greater comfort of use and a greater efficacy to the scissors.

### DESCRIPTION

The present invention concerns a new type of scissors for hairstylist.

It is known to everyone that for cutting hair hairstylists use various types of scissors according to the required type of cut.

However, for each type of cut, he or she always uses the most common type of straight blade scissors for shortening locks of hair. Using such straight scissors, the hairstylist cuts the length of a lock of hair so that the end of such a lock of hair follows a straight line. When he or she cuts the next lock of hair, again with the traditional straight blade scissors, he or she also obtaines a similar straight cut on the next lock of hair, the hair tips of the lock of hair forming a straight line. Because the locks of hair have different lengths, they overlap, forming thus unsightly chopping. The final cut is not very harmonic and not very natural, each lock of hair presenting a step-like break with respect to the adjacent lock of hair having longer or shorter length.

In order to solve such a drawback, when straight blade scissors of known type of the prior art are used, the hairstylist must pass again on each lock of hair with the same scissors or with scissors of different type. In particular, the hairstylist, in order to avoid unsightly chopping, after having cut the locks of hair to shorten the length thereof is forced to go over the end of each lock of hair again with the tip of the straight blade scissors or with different blades to texture the straight line formed by the straight blade scissors. For example, with the straight scissors, the hairstylist cuts each lock of hair, one by one, and shortens all lengths. Then, following the same course, he or she goes over the locks of hair again, once again one by one, to cut with the tips of the straight scissors or with thinning scissors. In order to solve the drawback which occurs with straight blade scissors of the known type, the hairstylist is forced to carry out an operation which is long as the first cutting operation in terms of time, if not longer, with the further drawback of risking ruining the results of the first step of cutting during the step of going over again.

It is thus the main task of the present invention to provide a new type of tool which allows to solve the aforesaid problems left unsolved by the scissors of the known type.

In the scope of this task, it is a further object of the present invention to provide a tool which allows hairstylists to save time during the cutting operation.

It is a further object of the present invention to provide a tool which allows to carry out both the cutting and the texturing of the lock of hair in one operation.

A further object of the present invention is to provide a tool which is comfortable to grip and use by the hairstylist.

A yet further object of the present invention is to provide a tool which is easy and intuitive to use both by expert and inexpert hairstylists, thus preventing the results of the first passage from being ruined during the second passage.

This task and other objects which will be more apparent below are reached by scissors of the type comprising two blades hinged to one another by a fixed pin and two handles, each of which is provided with a gripping eye, which is characterized in that at least one of said eyes is rotationally associated to one of said handles so as to be orientable, and in that each of said blades comprises a saw tooth profile, which protrudes in a direction substantially perpendicular to the side of said blade, said saw tooth profiles facing one another so as to form a zigzag cutting line.

Further features and advantages of the present invention will be more apparent in the following detailed description provided by way of non-limitative example and set forth in the accompanying figures, in which:

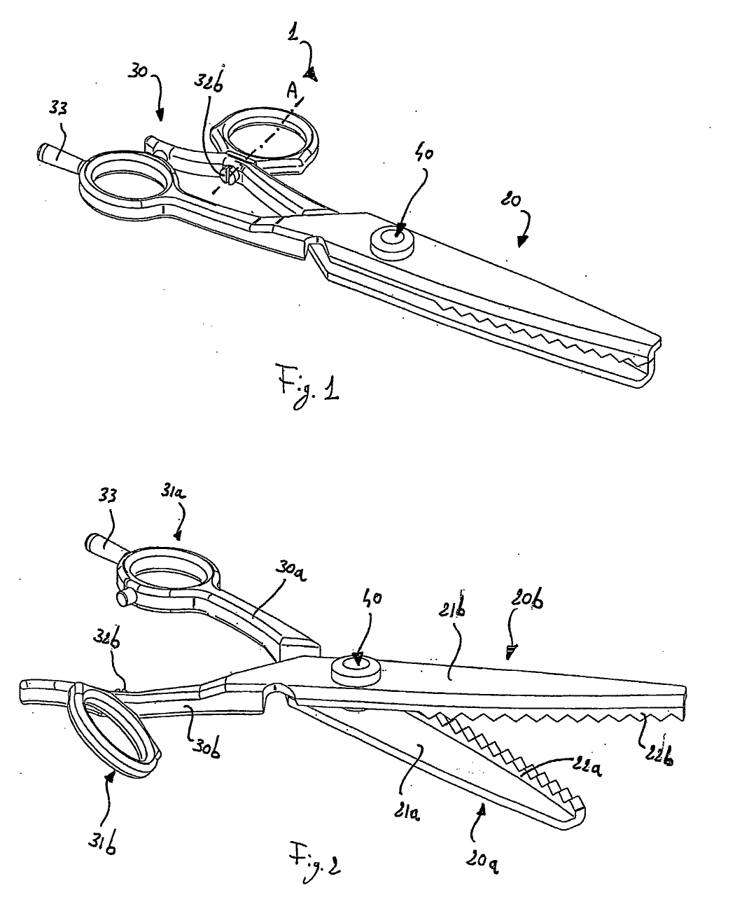

FIG. 1 is a perspective view of the scissors according to the present invention with the blades closed;

FIG. 2 is another a perspective view of the scissors according to the present invention with the blades opened.

According to a preferred embodiment of the present invention, shown by way of non-limiting example, the scissors according to the present invention comprise cutting means 20 comprising two blades 20a and 20b, said blades being hinged onto one another by means of a pin 40. A grip 30 comprising two handles 30a and 30b is connected to said cutting means 20. Each of said handles 30a and 30b is connected to one of said blades 20a and 20b, or is an extension thereof, the blade and the handle being made in one piece.

If the handles and blades are not made in one piece, i.e. are made of different materials, the handles may be advantageously made of plastic or rubbery material, ferrous alloys, aluminum alloys, composite materials, such as fiberglass, or carbon, in order to improve gripping comfort of the handle by the user and to improve the weight and the comfort of use of the tool.

According to a preferred embodiment of the present invention, each of said handles 30a and 30b further comprises an eye, 31a and 31b respectively, adapted to allow the gripping by the user by inserting his or her fingers. In particular, the embodiment in FIGS. 1 and 2 shows a pair of handles 30a and 30b provided with eyes 31a and 31b, at least one of which of said eyes being rotationally connected to the corresponding handle.

In particular, as shown in the embodiment illustrated by means of example in the attached figures, an eye 31b either pivots or is hinged by means of a cylindrical joint 32b to the handles 30b. The cylindrical joint allows to orient the eye by turning it about the axis A of the cylindrical joint 32b, said axis being substantially perpendicular to the longitudinal axis of the handle itself. The adjustability of the eye allows the user to grip the scissors in the most comfortable manner, usually by inserting his or her thumb in the adjustable eye.

A further pin 33, which protrudes outwards in the direction of the longitudinal axis of the handle 30a, may be contemplated on the handle opposite to the handle 30b. Said pin may be advantageously extended towards the outside of the fixed eye 31a of the handle 30a.

Again with reference to the accompanying figures, the scissors according to the present invention are characterized in that they comprise the two blades 20a and 20b, each of said blades 20a and 20b having, at the cutting edge thereof, a saw tooth profile 22a, 22b which extends in direction substantially perpendicular to the side 21a, 21b of said blade, so that said saw tooth profiles 22a, 22b face one another and so that the crests of the serration of a blade mate with the grooves of the serration of the opposite blade when the blades of the scissors are closed to perform the cut.

The presence of the serration at the cutting edge of each blade allows to obtain a cutting line which is a zigzag line, instead of being straight, as in the case of straight blade scissors of known type.

In the field of use of the present invention, the zigzag cutting line is translated into a texturing of the line identified by the hair tips which form the lock of hair. In particular, by using the scissors according to the invention to cut for shortening the length of the locks of hair, the hairstylist directly obtains a zigzag pattern of the edge of the lock of hair formed by the tips, in this manner the subsequent operation of texturing of the tip of the locks of hair that the hairstylist was forced to perform with the tip of the straight scissors or with other known scissors, proceeding with a second passage on each single lock of hair, is no longer necessary.

We have thus shown how the scissors according to the present invention reach the suggested objects.

In particular, we have shown how the scissors according to the present invention allow a high ease of use for the user and manageability of the tool by virtue of the grip with adjustable eye, while the simultaneous presence of the serrated blade allows the hairstylist to cut the lock of hair and trim the profile of the tips in a single operation, thus optimizing cutting times and methods. In particular, we have shown that the scissors according to the present invention allows the hairstylist to reduce by up to 30/40% the time needed for various types of cuts, thus completely eliminating the second step of cutting which is currently needed to trim the tips when straight blade scissors are used.

We have furthermore advantageously shown how the tool according to the present invention can be used by both expert hairstylists and beginners because the second passage always has a margin of error with the risk of ruining the result of the first cutting passage.

The convenience of use of the tool according to the present invention obtained also by virtue of the special grip is thus associated to a particular efficacy of use in cutting because it simplifies the steps, thus drastically reducing time, in addition to obtaining a better final result, because the profile moved by the edge of the lock of hair is made directly by the scissors and is not obtained by the hairstylist during the second passage.

Many changes may be made by a person skilled in the art without departing from the scope of protection of the present model.

Therefore, the scope of protection of the claims is not limited to illustrations or preferred embodiments shown in the description of the present invention found in form of example, but instead all the different embodiments of the invention which reach equivalent utility by implementing the same inventive concept are comprised within the scope of the present model.

1. Scissors for hairstylist of the type comprising two blades hinged to one another by a fixed pin and two handles, each of which is provided with a gripping eye wherein at least one of said eyes is rotationally associated to one of said handles and in that each of said blades comprises a saw tooth profile which extends in direction substantially perpendicular to one side of said blade, said saw tooth profiles facing one another so as to form a cutting zone.

2. Scissors according to claim 1, wherein said saw tooth profiles face one another so that the crests of the serration of one blade mate which the grooves of the serration of the adjacent blade, so as to make a zigzag cutting line when the scissor blades are closed.

3. Scissors according to claim 2, wherein said eye rotationally associated to one of said handles is hinged by means of a cylindrical joint having an axis of rotation (A) substantially perpendicular to the longitudinal axis of said handle.

4. Scissors according to claim 3, wherein it further comprises a pin integrally associated to the handle opposite to the handle provided with a rotational eye and protruding outwards from said handle in the direction of the longitudinal axis of the handle itself.

5. Scissors according to claim 4, wherein each blade is made in one piece with the handle with which it is integral.

6. Scissors according to claim 5, wherein said blades and said handles are made of metallic material.

7. Scissors according to claim 1, wherein each blade is integrally connected to a handle.

8. Scissors according to claim 7, wherein each of said handles is at least partially made of plastic material.

9. Scissors according to claim 7, wherein each of said handles is at least partially made of composite material, such as fiberglass or carbon.

10. Scissors according to claim 7, wherein each of said handles is at least partially made of rubbery material.

11. Scissors according to claim 7, wherein each of said handles is at least partially made of aluminum or alloys thereof.
